(19) United States
(12) Patent Application Publication
(10) Pub. No.: US 2011/0076519 A1
(43) Pub. Date: Mar. 31, 2011

(54) Systems and Methods for Sustainable Wastewater and Biosolids Treatment

(76) Inventors: Kartik Chandran, New York, NY (US); Timothy Chang, Rego Park, NY (US)

(21) Appl. No.: 12/679,554

(22) PCT Filed: Oct. 6, 2008
(86) PCT No.: PCT/US08/78934

§ 371 Date: Dec. 6, 2010

Related U.S. Application Data
(60) Provisional application No. 60/977,419, filed on Oct. 4, 2007.

(51) Int. Cl. H01M 8/16

(52) U.S. Cl. 429/2

(57) ABSTRACT

Methods of sustainable wastewater and biosolids treatment using a bioreactor including a microbial fuel cell are disclosed. In some embodiments, the methods include the following: enriching an anode of the microbial fuel cell in the bioreactor with a substantially soluble electron acceptor; growing the bacteria in the presence of the anode enriched with a substantially soluble electron acceptor; oxidizing a substrate using the bacteria to produce free electrons; channeling the free electrons away from a terminal electron acceptor and to the enriched anode, the enriched anode serving as an electron acceptor; and carrying the free electrons from the enriched anode to a cathode of the microbial fuel cell to generate electricity.

### CROSS REFERENCE TO RELATED APPLICATION(S)

This application claims the benefit of U.S. Provisional Application No. 60/977,419, filed Oct. 4, 2007, which is incorporated by reference as if disclosed herein in its entirety.

### BACKGROUND

Many current wastewater treatments include the use activated sludge. The use of activated sludge is a century-old, energy intensive, aerobic process, which requires pumping oxygen into a reactor. Processes including activated sludge are costly. The annual costs of treating U.S. wastewater alone are $25 billion and escalating. It is estimated that many more billions will be needed in future decades to maintain and replace ageing infrastructure. Furthermore, expanding wastewater infrastructure to accommodate an increasing population adds to this cost. Globally, there is an urgent need for low-cost water treatment technologies in developing countries and rural areas. In recent years, numerous studies have examined the feasibility of new, energy-saving, anaerobic treatment technologies. These include biogas reactors and bio-electrochemical systems. Microbial fuel cells (MFC), a type of bio-electrochemical system, directly capture electrons produced by microbial catabolism. MFCs utilize bacteria in a bioreactor to generate electricity from organic material, including wastewater. Biogas reactors convert biomass into a gaseous intermediate molecule, such as methane or hydrogen, which reduces the efficiency of the system.

Although the principles behind MFC technology were discovered approximately 100 years ago, only in the past decade has the technology received renewed attention as a promising source of alternative energy. Recent MFC research has yielded many experimental designs and intriguing results. Some configurations use carbon rods as anodes and carbon paper exposed directly to air as a cathode. Other designs incorporate platinum catalysts into the cathode, employ a proton exchange membrane for ion transfer, and or use electron mediator molecules to shuttle electrons between the microorganisms and the anode. However, all MFCs include substantially similar operating principles: the oxidation of a carbon source occurs at the anode while the reduction of oxygen to water occurs at the cathode. Much research still needs to be done with current MFCs to make them practical and cost efficient. Platinum catalysts and proton-exchange membranes are commonly used in experiments, but both are expensive and would be impractical to implement on a large scale. Electron mediator molecules can dramatically increase power output, but many of these molecules are toxic and non-renewable, detracting from the environmental benefits of the system. Current MFC technologies produce little energy per fuel cell and thus have limited use.

### SUMMARY

Methods of sustainable wastewater and biosolids treatment using a bioreactor including a microbial fuel cell are disclosed. In some embodiments, the methods include the following: enriching an anode of the microbial fuel cell in the bioreactor with a substantially soluble electron acceptor; growing the bacteria in the presence of the anode enriched with a substantially soluble electron acceptor; oxidizing a substrate using the bacteria to produce free electrons; channeling the free electrons away from a terminal electron acceptor and to the enriched anode, the enriched anode serving as an electron acceptor; and carrying the free electrons from the enriched anode to a cathode of the microbial fuel cell to generate electricity.

Systems for producing a microbial fuel cell having improved electricity generating capabilities are disclosed. In some embodiments, the systems include the following: a bioreactor module including the following: a bioreactor having a microbial fuel cell; and a substantially soluble electron acceptor for enriching an anode of the microbial fuel cell in the bioreactor; a transfer module including means for serially transferring bacteria grown in the presence of the anode enriched with a substantially soluble electron acceptor from the bioreactor to a second bioreactor having a microbial fuel cell thereby seeding the second bioreactor; a treatment module including the second bioreactor having a microbial fuel cell means for oxidizing elements of domestic wastewater, biosolids, and combinations thereof using primarily the serially transferred bacteria, and means for generating electricity.

Methods of sustainable wastewater and biosolids treatment using a bioreactor including a microbial fuel cell are disclosed. In some embodiments, the methods include the following: enriching an anode of the microbial fuel cell in the bioreactor with iron (iii) chloride; growing the bacteria in the presence of the anode enriched iron (iii) chloride; oxidizing a substrate using the bacteria to produce free electrons; channeling the free electrons away from a terminal electron acceptor and to the enriched anode, the enriched anode serving as an electron acceptor; and carrying the free electrons from the enriched anode to a cathode of the microbial fuel cell to generate electricity.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of a system according to some embodiments of the disclosed subject matter;

FIG. 2 is a side section view of a microbial fuel cell according to some embodiments of the disclosed subject matter;

FIG. 3 is a top plan view of a microbial fuel cell take along line 3-3 of FIG. 2;

FIG. 4 is a diagram of a method according to some embodiments of the disclosed subject matter;

FIG. 5 is a graph of voltage (and consequently power) production over time before and 20 hours after a nutrient spike for systems and methods according to some embodiments of the disclosed subject matter;

FIG. 6 is a graph of ammonium concentrations in two reactors according to some embodiments of the disclosed subject matter before and after a glucose-ammonium spike solution was added;

FIG. 7 is a graph of voltage (and consequently power) production over time for systems and methods according to some embodiments of the disclosed subject matter; and

FIG. 8 is a graph of voltage production over time for systems and methods according to some embodiments of the disclosed subject matter.

### DETAILED DESCRIPTION

A microbial fuel cell is an anaerobic bioreactor in which bacteria oxidize various substrates to produce free electrons. The electrons are channeled away from the terminal electron acceptor to an anode. A conductive wire carries the electrons from the anode to the cathode, creating electricity that can be captured and used as a source of energy. If wastewater and biosolids is used as the substrate, operation of a microbial fuel cell can be used to treat the wastewater and biosolids and generate electricity.

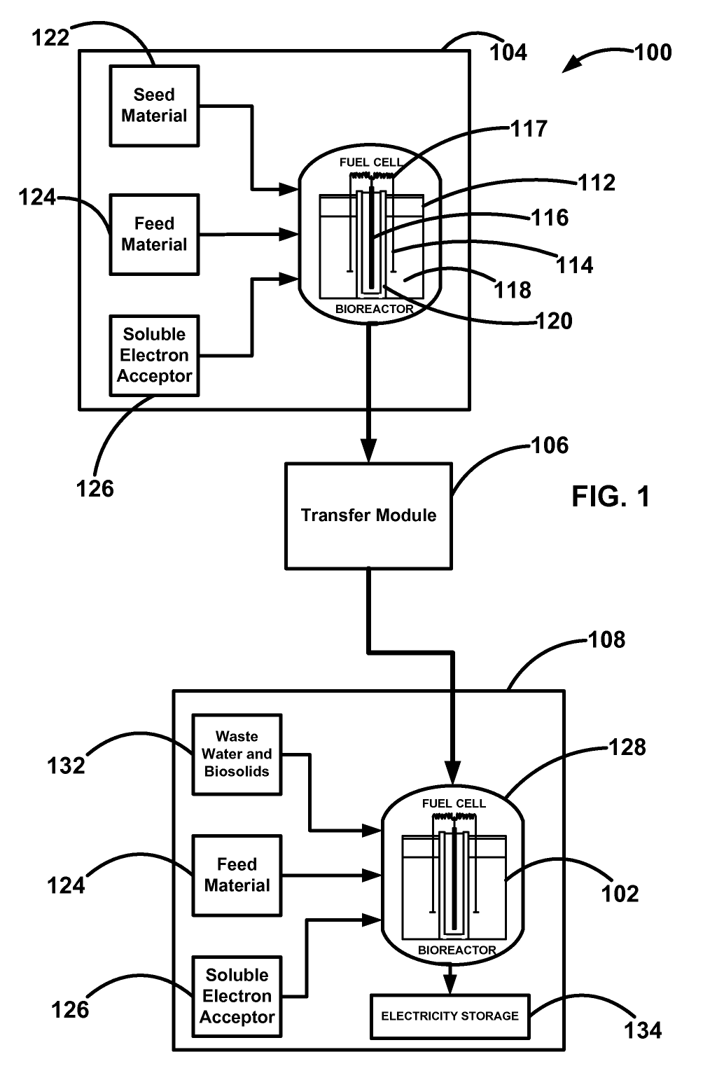

Generally, the disclosed subject matter relates to systems and methods for sustainable treatment of wastewater and biosolids using improved microbial fuel cells. Referring now to FIGS. 1-3, some embodiments include a system 100 for producing a microbial fuel cell 102 having improved electricity generating capabilities. In some embodiments, system 100 includes a bioreactor module 104, a transfer module 106, and a treatment module 108.

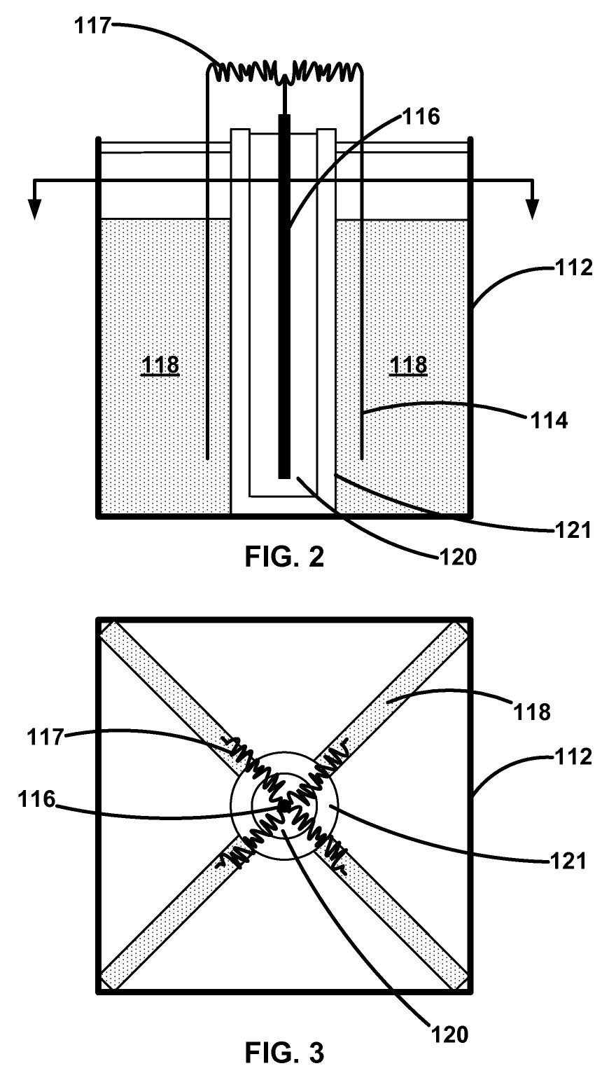

As best shown in FIGS. 2 and 3, bioreactor module 104 includes combined bioreactor/microbial fuel cell 112. Microbial fuel cell 112 includes an anode 114 and a cathode 116 that are in electrical communication with one another via a wire 117. Anode 114 is typically defined by a plurality of anode panels 118 that are enriched with iron (iii) chloride or another substantially soluble electron acceptor. Cathode 116 is positioned in a central cathode chamber 120 defined by a porous tubular structure 121 that is surrounded by plurality of anode panels 118.

Referring again to FIG. 1, bioreactor module 104 includes seed material 122 for seeding bioreactor 112 with material containing bacteria for oxidizing a substrate. A feed material 124 is included to serve as a principal electron donor to encourage the growth of the bacteria in bioreactor 112. A substantially soluble electron acceptor 126 is included for enriching anode 114 of microbial fuel cell 112. Again, substantially soluble electron acceptor 126 is typically iron (iii) chloride, but can be other substantially soluble electron acceptors.

Transfer module 106 includes standard apparatus and equipment (not shown) for serially transferring bacteria grown in the presence of anode 114 enriched with substantially soluble electron acceptor 126 from bioreactor 112 to a second bioreactor 128 having microbial fuel cell 102 thereby the seeding second bioreactor.

Treatment module 108 includes second bioreactor 128 and microbial fuel cell 102 and standard apparatus and equipment (not shown) for introducing a flow of domestic wastewater and biosolids 132 to the second bioreactor. Similar to bioreactor 112 and as discussed above, second bioreactor 128 is configured to oxidize elements of the domestic wastewater and biosolids using primarily the serially transferred bacteria. Operation of system 100 and microbial fuel cell 130 causes the production of free electrons. Enriched anode 114 of microbial fuel cell 102 channels the free electrons away from a terminal electron acceptor and to the enriched anode, which serves as an electron acceptor. Wire 117 carries the free electrons from enriched anode 114 to cathode 116 to generate the electricity. The electricity is typically captured and stored to be used as an energy source 134.

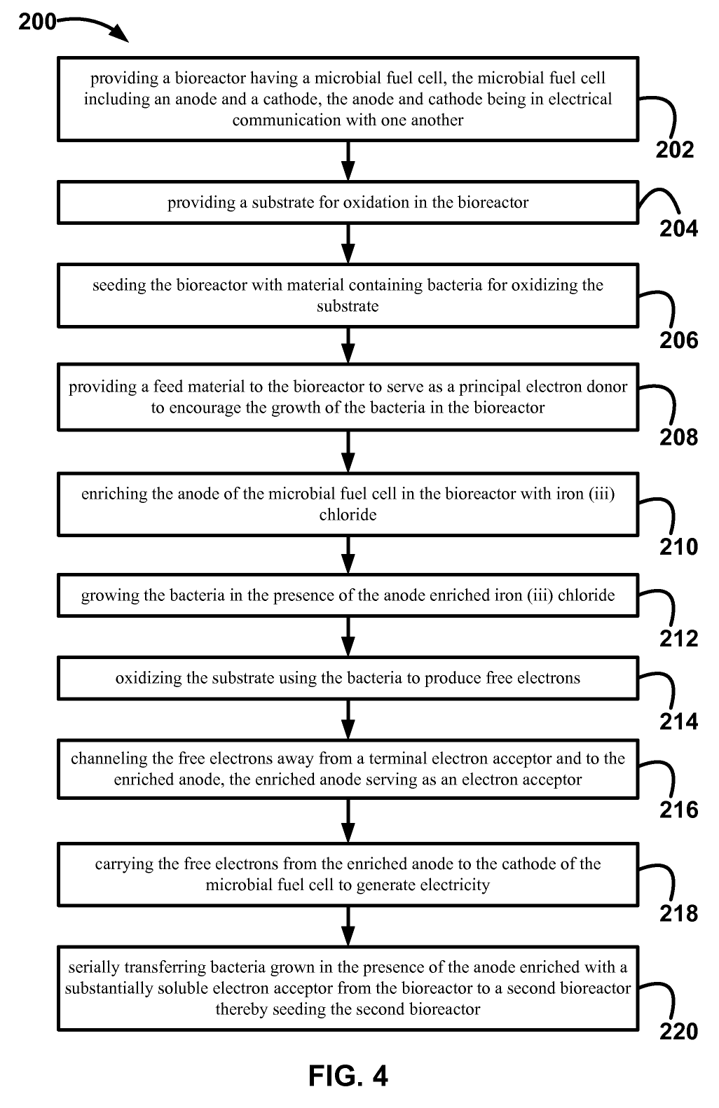

Referring now to FIG. 4, some embodiments of the disclosed subject matter include a method 200 of sustainable wastewater and biosolids treatment using a bioreactor including a microbial fuel cell. At 202, method 200 includes providing a bioreactor having a microbial fuel cell. The microbial fuel cell includes an anode and a cathode that are in electrical communication with one another. At 204, a substrate that is to be oxidized is provided in the bioreactor. The substrate typically includes domestic wastewater, but can be any other material such as biosolids produced in wastewater treatment plant. Typically, and particularly when used to treat domestic wastewater, the substrate is provided via a continuous flow or refillable batch. At 206, the bioreactor is seeded with material containing bacteria for oxidizing the substrate. In some embodiments, seeding includes adding an amount of a nitrifying biomass to the bioreactor. At 208, a feed material is provided to the bioreactor to serve as a principal electron donor, which encourages the growth of the bacteria in the bioreactor. In some embodiments, the feed material includes acetate but can also include any other substances that encourage the growth of the bacteria. At 210, the anode of the microbial fuel cell is enriched with iron (iii) chloride or another substantially soluble electron acceptor. At 212, the bacteria are grown in the presence of the anode enriched with iron (iii) chloride, which facilitates propagation of a community of bacteria with iron-reducing capabilities. At 214, the substrate oxidized by the bacteria to produce free electrons. At 216, the free electrons are channeled away from a terminal electron acceptor and to the enriched anode, which serves as an electron acceptor. At 218, the free electrons are carried from the enriched anode to the cathode of the microbial fuel cell to generate electricity. The electricity is typically captured and stored for use as a source of energy. At 220, bacteria grown in the presence of the anode enriched with a substantially soluble electron acceptor is serially transferring from a first bioreactor to a second bioreactor thereby seeding the second bioreactor.

Laboratory scale systems and methods according to the disclosed subject matter were tested. Kinetics tests to determine general consumption rates were designed around a nutrient spike. These tests monitored biomass, ammonia concentration, pH, chemical oxygen demand (COD) concentration, and voltage. Ammonia tests were performed every hour, while COD and biomass collection tests were taken every 2 hours. Voltage was measured every 10 seconds with the data recording device. For each sample removed, an equal volume of tap water was added to the reactor.

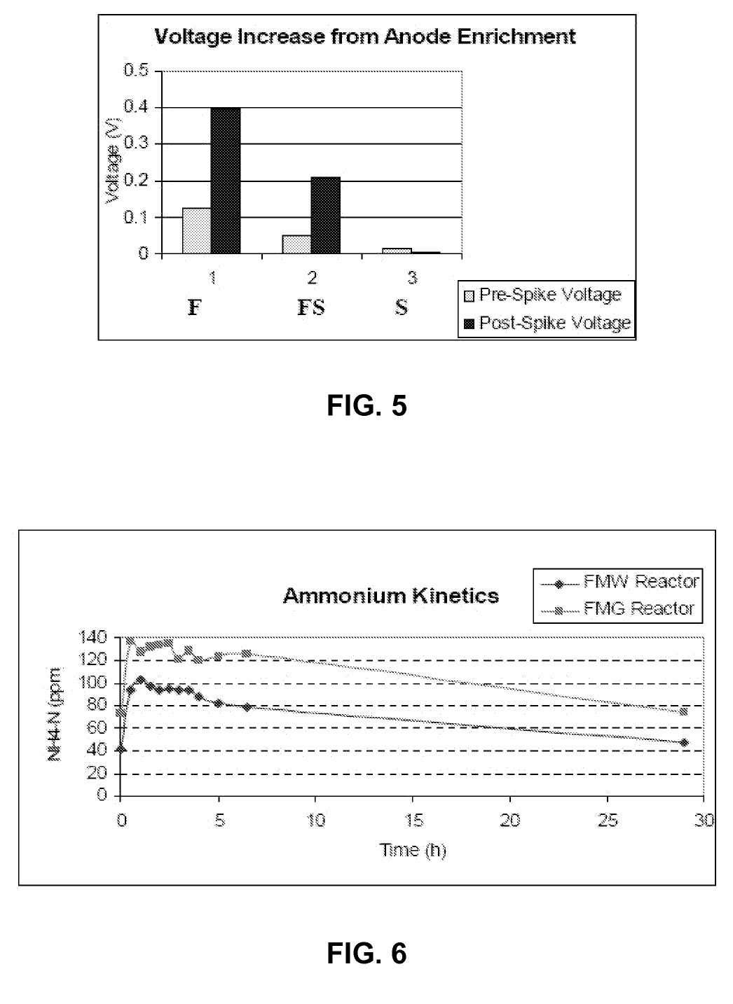

Tests were performed to determine the voltage generated during operation of MFCs including anodes enriched with various electron acceptors. A first MFC (“F reactor”) included an anode enriched with iron (iii) chloride, a second MFC (“FS reactor”) included an anode enriched with iron (iii) sulfate, and a third MFC (“S reactor”) included an anode enriched with sodium sulfate. As shown in FIG. 5, the largest increase in voltage over time, and consequently, the best performing community, was in the F reactor, which was enriched with iron (iii) chloride. The FS reactor, which was enriched with iron (iii) sulfate, also experienced an increase, although a smaller one, and the S reactor, which was enriched with sodium sulfate showed no increase in voltage.

Qualitatively, a thick, orange biofilm was observed on the anode of the FS reactor and a thin, red-orange biofilm was observed on the F reactor anode. A few gray strands were observed on the anode of the S reactor, although this reactor had the most turbid bulk phase medium.

Calculations of typical power received from the voltage data are as follows:

$$P = \frac{{V}^{2}}{R} = \frac{{( 0.40 V )}^{2}}{10.0 Ω} = \frac{16 mW}{0.0377 {m}^{2}} = 424 \frac{mW}{{m}^{2}} . \qquad [ Equation 1 ]$$

Measurements of ammonium concentrations were taken in two reactors, the “FMG reactor” and the “FMW reactor” before and after a glucose-ammonium spike solution was added. As shown in FIG. 6, ammonium concentrations after a spike show a steady decrease in concentration. Approximately one day after the spike, ammonium concentrations returned to baseline levels. The baseline is most likely sustained by endogenous decay in the reactor.

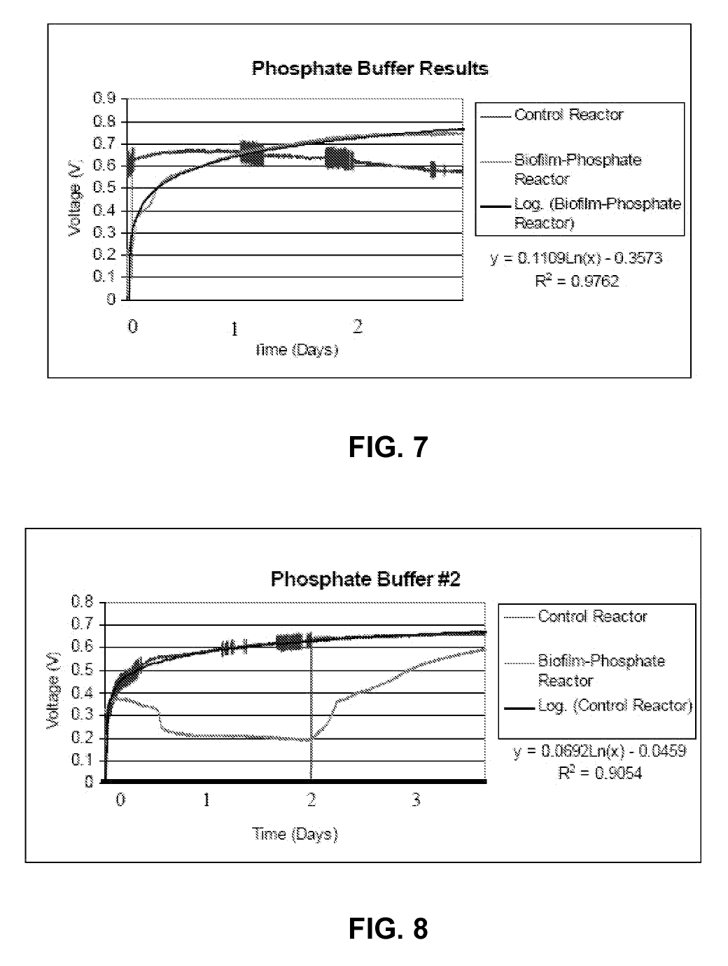

To analyze the importance of a biofilm in electricity production, tests were performed to compare results from the biofilm community (“biofilm-phosphate reactor”) and from microorganisms in the bulk phase-liquid or planktonic state (“control reactor”). In a first test, the biofilm-phosphate reactor had its media drained away and the anode was submerged in a phosphate buffer of pH 7.1. The control reactor retained both its anode and media. Following this, both reactors were spiked with the glucose/ammonia solution and voltage was monitored for three days. As shown in FIG. 7, the nutrient spike given to biofilm-phosphate reactor, which included a thick, gray biofilm in a phosphate buffer, resulted in a logarithmic increase in voltage. In the control reactor, the nutrient spike caused a slow and short increase in voltage followed by a decrease in voltage to below baseline levels.

Referring now to FIG. 8, a second test was performed to analyze whether an increase in voltage was attributed to a new phosphate buffer or to a spike of glucose-ammonium solution and a third test analyzed how keeping the bulk phase media in the control reactor while adding a fresh anode with no biofilm on it affected electricity output. The voltage was monitored for three days.

In the second test, the biofilm-covered anode from the control reactor was submerged into a new phosphate buffer (“biofilm-phosphate reactor”), yet the reactor was not given a nutrient spike for one day. A delayed spike in the biofilm-phosphate reactor demonstrates that the logarithmic growth in voltage is caused by the addition of glucose-ammonium solution itself and not by the phosphate buffer.

In the third test, the anode of the control cell was replaced with a fresh anode that had no biofilm. The new anode was submerged and a spike was immediately given. Still referring to FIG. 8, in the control reactor, a slow logarithmic increase in voltage was observed. The R² constant is not as high as the ones associated with the biofilm-phosphate reactors. A possible explanation for this is the lack of a biofilm at the beginning of the test, followed by the acquisition of a thick gray biofilm toward the end of the test.

Maximum power was generated during the second phase of the experiment in the FM reactor. These calculations are shown here:

$$P = \frac{{V}^{2}}{R} = \frac{{( 0.67 V )}^{2}}{10.0 Ω} = \frac{44.89 mW}{0.0377 {m}^{2}} = 1190 \frac{mW}{{m}^{2}} . \qquad [ Equation 2 ]$$

Efficiency measurements assess how well the microbial community is oxidizing substrate. The Nernst equation relates the free energy of a particular reaction to the voltaic potential difference of the reaction. This equation can then be modified for the particular concentrations of reactants and products present in the reactor. The standard potential for a reactor according to the disclosed subject matter was calculated to be 1.244 V for the oxidation of glucose to carbon dioxide coupled with the reduction of oxygen to water. The following is a calculation of the Nernst Equation for this standard potential with the concentration of glucose added into each nutrient spike:

$$∴ {ξ}_{cell} = 1.24 V - ( 2.46 * {10}^{- 3} ) log ( \frac{{[ {CO}_{2} ]}^{6}}{{[ 0.0056 ] [ {O}_{2} ]}^{6}} ) . \qquad [ Equation 3 ]$$

At the start of each spike, a bubbler was passed through the cathode chamber, e.g., the second iteration of tests, to saturate the solution with air, which created an oxygen concentration of 7.0 parts per million (ppm). From this, as well as the proportion of oxygen to carbon dioxide in air, the aqueous concentration of carbon dioxide can be calculated from Henry's Law. The following is a calculation of the Nernst equation while including these values:

$$\begin{matrix}∴ {ξ}_{cell} = 1.24 V - ( 2.46 * {10}^{- 3} ) log ( \frac{{[ 5.14 \cdot {10}^{- 7} ]}^{6}}{{[ 0.0056 ] [ 2.19 \cdot {10}^{- 4} ]}^{6}} ) \\ = 1.27 V\end{matrix} \qquad [ Equation 4 ]$$

As a result, the maximum possible voltage attainable was calculated to be 1.27 V. Comparing this to the maximum observed voltage, simple efficiency calculations yield the following:

$$\begin{matrix}Efficiency = \frac{{V}_{act}}{{V}_{th}} \cdot 100 \\ = \frac{0.784 V}{1.27 V} \cdot 100 \\ = 61.7 \% Efficiency .\end{matrix} \qquad [ Equation 5 ]$$

Thus, the cell is producing approximately 62% of the voltage it could possibly produce if it were an inorganic reaction operating at 100% efficiency.

As shown in the test results, systems and methods including microbial fuel cell according to the disclosed subject matter succeeded in simultaneously generating power and degrading organic nitrogen and carbon in wastewater. As shown in Equation 5, the Nernst equation and efficiency calculations yielded an efficiency of nearly 62.

Referring to Equation 2, it was shown in preliminary tests that the reactors according the disclosed subject matter produced approximately 1.2 W/m² across a 10Ωresistor. This power density is on the high end of those in known systems. As shown in Equations 4 and 5, in the absence of a resistor, voltaic efficiencies are consistent with the energy theoretically produced by the reaction and consumed by the microorganisms.

The high voltaic efficiency reveals that the microbial community is properly carrying out the oxidation half-reaction. This indicates that that the MFCs according to the disclosed subject matter can be effective for bioremediation. Fast consumption kinetics and high efficiency rates mean more wastewater or biosolids can be processed for a given MFC volume.

Data from the phosphate buffer experiment, in which biofilm bacteria were shown to be responsible for most of the energy production, were highly reproducible. As shown in FIGS. 5 and 6, the logarithmic regression curves for each of the graphs of voltage growth over time show a high R² correlation coefficient indicating a high conformation to a mathematical model. This test showed the biofilm-phosphate buffered reactor produced voltage at a greater rate than did the control reactor. Qualitatively, the fact that the control reactor, which included a fresh anode, grew a biofilm spontaneously suggests this is a preferred state for these electricity-producing bacteria to grow in. It can also mean equilibrium exists between the two types of bacteria.

SO₄²⁻ reduction to H₂S plays a role in inhibiting electron transfer to the cathode. The high concentration of sulfate makes it a more convenient electron acceptor. As shown in FIG. 5, the reactor with the least sulfate in it, i.e., with an iron (iii) chloride-enriched anode, produced the most power.

However, the presence of iron likely played a more significant role than the lack of sulfate did in selecting for an electricity-producing community. Species have been discovered that reduce iron (iii) to iron (ii) in their natural environment. Insoluble iron and soluble iron compounds present in a reactor select for organisms with this capability. Supporting this argument is the observation that the population was changing in terms of color and odor. Thus, over time it is reasonable to expect the population will become more productive.

Extracting energy from a system treating wastewater and biosolids cuts down on treatment costs and is a step towards sustainable wastewater treatment. This system can be of value in both developed and undeveloped areas of the world as well as for a variety of isolated, small-scale applications, including those at sea or in space.

Systems and methods according to the disclosed subject matter provide advantages and benefits over known systems and methods. Systems and methods according to the disclosed subject matter allow for production of electricity using bacteria from wastewater and biosolids. At the same time, systems and methods according to the disclosed subject matter can be used for wastewater treatment, as energy production uses the organic wastes as a substrate in energy production. Technology according to the disclosed subject matter can be used as a convenient power source for portable electronics and can be used for power generation for developing countries that don't have well established power grids.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of sustainable wastewater and biosolids treatment using a bioreactor including a microbial fuel cell, said method comprising:
enriching an anode of said microbial fuel cell in said bioreactor with a substantially soluble electron acceptor;
growing said bacteria in the presence of said anode enriched with a substantially soluble electron acceptor;
oxidizing a substrate using said bacteria to produce free electrons;
channeling said free electrons away from a terminal electron acceptor and to said enriched anode, said enriched anode serving as an electron acceptor; and
carrying said free electrons from said enriched anode to a cathode of said microbial fuel cell to generate electricity.

2. The method according to claim 1, wherein said substantially soluble electron acceptor is iron (iii) chloride.

3. The method according to claim 1, further comprising:
providing a substrate for oxidation in said bioreactor, wherein said substrate includes domestic wastewater, biosolids, and a combination thereof.

4. The method according to claim 1, further comprising:
providing a feed material to said bioreactor to serve as a principal electron donor to encourage the growth of said bacteria in said bioreactor, wherein said feed material includes acetate.

5. The method according to claim 2, wherein growing said bacteria in the presence of said anode enriched with iron (iii) chloride facilitates propagation of a community of bacteria with iron-reducing capabilities.

6. The method according to claim 3, wherein providing a substrate for oxidation in said bioreactor includes providing a continuous flow or refillable batch of said substrate.

7. The method according to claim 1, further comprising:
seeding said bioreactor with material containing bacteria for oxidizing said substrate, said seeding including adding an amount of a nitrifying biomass to said bioreactor.

8. The method according to claim 1, wherein said electricity is captured and stored.

9. The method according to claim 1, further comprising:
serially transferring bacteria grown in the presence of said anode enriched with a substantially soluble electron acceptor from said bioreactor to a second bioreactor thereby seeding said second bioreactor.

10. A system for producing a microbial fuel cell having improved electricity generating capabilities, said system comprising:
a bioreactor module including the following:
a bioreactor having a microbial fuel cell; and
a substantially soluble electron acceptor for enriching an anode of
said microbial fuel cell in said bioreactor;
a transfer module including means for serially transferring bacteria grown in the presence of said anode enriched with a substantially soluble electron acceptor from said bioreactor to a second bioreactor having a microbial fuel cell thereby seeding said second bioreactor;
a treatment module including said second bioreactor having a microbial fuel cell means for oxidizing elements of domestic wastewater, biosolids, and combinations thereof using primarily said serially transferred bacteria, and means for generating electricity.

11. The system according to claim 10, wherein said substantially soluble electron acceptor is iron (iii) chloride.

12. The system according to claim 10, wherein said treatment module includes means for producing free electrons, means for channeling said free electrons away from a terminal electron acceptor and to said enriched anode, said enriched anode serving as an electron acceptor; and means for carrying said free electrons from said enriched anode to a cathode of said microbial fuel cell to generate said electricity.

13. The system according to claim 10, wherein said microbial fuel cell further comprises:
a plurality of anode panels defining said anode, said plurality of anode panels being enriched with iron (iii) chloride; and
a central cathode chamber, said cathode positioned therein.

14. A method of sustainable wastewater and biosolids treatment using a bioreactor including a microbial fuel cell, said method comprising:
enriching an anode of said microbial fuel cell in said bioreactor with iron (iii) chloride;
growing said bacteria in the presence of said anode enriched iron (iii) chloride;
oxidizing a substrate using said bacteria to produce free electrons;
channeling said free electrons away from a terminal electron acceptor and to said enriched anode, said enriched anode serving as an electron acceptor; and
carrying said free electrons from said enriched anode to a cathode of said microbial fuel cell to generate electricity.

15. The method according to claim 14, further comprising:
providing a substrate for oxidation in said bioreactor, wherein said substrate includes domestic wastewater, biosolids, and a combination thereof.

16. The method according to claim 14, further comprising:
providing a feed material to said bioreactor to serve as a principal electron donor to encourage the growth of said bacteria in said bioreactor, wherein said feed material includes acetate.

17. The method according to claim 14, wherein growing said bacteria in the presence of said anode enriched with iron (iii) chloride facilitates propagation of a community of bacteria with iron-reducing capabilities.

18. The method according to claim 15, wherein providing a substrate for oxidation in said bioreactor includes providing a continuous flow or refillable batch of said substrate.

19. The method according to claim 14, further comprising:
seeding said bioreactor with material containing bacteria for oxidizing said substrate, wherein seeding said bioreactor with material containing bacteria for oxidizing said substrate includes adding an amount of a nitrifying biomass to said bioreactor.

20. The method according to claim 14, further comprising:
serially transferring bacteria grown in the presence of said anode enriched with a substantially soluble electron acceptor from said bioreactor to a second bioreactor thereby seeding said second bioreactor.
